(19) United States
(12) Patent Application Publication
(10) Pub. No.: US 2009/0187292 A1
(43) Pub. Date: Jul. 23, 2009

(54) INTEGRATED PITCH, ROLL, AND YAW INCEPTOR

(76) Inventors: Mark Andrew Hreha, Alton, IL (US); Dean Francis Guilmett, O'Fallon, MO (US); John Glenn Bolling, Maryland Heights, MO (US)

Correspondence Address: DUKE W. YEE, YEE & ASSOCIATES, P.C., P.O. BOX 802333, DALLAS, TX, 75380, US

(21) Appl. No.: 12/015,848

(22) Filed: Jan. 17, 2008

(51) Int. Cl. G05D 1/08; B64C 13/04

(52) U.S. Cl. 701/4; 244/237

(57) ABSTRACT

A method and apparatus for a control system for an aircraft. The control system comprises a grip, a set of feedback components connected to the grip, and a set of sensors. The set of feedback components transmit a restoring force opposite to a movement of the grip. The set of sensors are capable of detecting pitch input, roll input, and yaw input in response to the movement of the grip.

### BACKGROUND INFORMATION

1. Field

The present disclosure relates generally to an aircraft and in particular to a method and apparatus for controlling an aircraft. Still more particularly, the present disclosure relates to a method and apparatus for controlling an aircraft with an inceptor.

2. Background

An aircraft may have various orientations while it is in the air. These orientations may be with respect to three axes on an X, Y, and Z coordinate system relative to the aircraft. An aircraft in flight may have various orientations with respect to the aircraft's surrounding. These orientations may be in three dimensions when the aircraft is in flight and may be in two dimensions when the aircraft is on the ground. The aircraft orientations are also referred to as attitudes. The pitch of an aircraft is one type of vehicle orientation. The pitch is one angle that specifies the orientation of the aircraft with respect to the horizon. In other words, the pitch indicates whether the nose of the aircraft is pointing upwards, level to the horizon, or pointing downwards.

The roll of an aircraft specifies whether the aircraft is banked to the left or right about a longitudinal axis through the body of the aircraft. In other words, the roll indicates the angle of the wings relative to the horizon. The yaw of an aircraft is the rotation of the aircraft about a normal axis through the body of the aircraft. The pitch, roll, and yaw for an aircraft may be described using various parameters, such as angles.

The flight of an aircraft may be controlled through cockpit controls, such as a control stick and rudder pedals. A control stick is typically used to control the roll and pitch of an aircraft, while rudder pedals are typically used to control the yaw of an aircraft. Controlling the yaw may occur in situations, such as, for example, landing in a cross wind. A pilot may adjust the yaw to take into account the presence of a cross wind.

Trim of the aircraft may be an automatic or manual input through the aircraft controls to set and hold specific pitch, roll or yaw attitudes. Once set, the trim can be increased or decreased as required by different flight conditions and flight operations.

### SUMMARY

The advantageous embodiments provide a method and apparatus for a control system for an aircraft. The control system comprises a grip, a set of feedback components connected to the grip, and a set of sensors. The set of feedback components transmit a restoring force to return the grip to a neutral position following input of pitch, roll and yaw commands. The set of sensors are capable of detecting pitch input, roll input, and yaw input in response to the movement of the grip.

In another advantageous embodiment, an apparatus comprises a flight control computer, an inceptor, and a plurality of flight control actuators. The inceptor is connected to the flight control computer and is capable of detecting pitch input, roll input, and yaw input generated by an operator manipulating a hand controller. The plurality of flight control actuators is in communication with the flight control computer and is connected to a plurality of control effectors. An input detected by the inceptor is translated into a signal by the flight control computer to selectively activate a set of flight control actuators in the plurality of flight control actuators.

In still yet another advantageous embodiment, a method is presented for controlling an aircraft during flight. Movement of an inceptor is detected, wherein the inceptor is capable of movement to generate input for pitch, roll, and yaw of the aircraft. A yaw input signal is generated in response to detecting the movement of the inceptor about the yaw control axis. A state of a set of control effectors capable of controlling movement of the aircraft about a yaw axis for the aircraft is selectively changed in response to the yaw input signal.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the advantageous embodiments are set forth in the appended claims. The advantageous embodiments, however, as well as a preferred mode of use, further objectives and advantages thereof, will best be understood by reference to the following detailed description of an advantageous embodiment of the present disclosure when read in conjunction with the accompanying drawings, wherein:

FIG. 1 is a diagram of an aircraft in which an advantageous embodiment may be implemented;

FIG. 2 is a block diagram illustrating components in a flight control system in accordance with an advantageous embodiment;

FIG. 3 is a diagram illustrating an inceptor in accordance with an advantageous embodiment;

FIG. 4 is a diagram of a data processing system in accordance with an illustrative embodiment of the present invention;

FIG. 5 is a diagram illustrating software components that may be used in a flight control computer in accordance with an advantageous embodiment

FIG. 6 is a flowchart of a process for handling mode transitions in accordance with an advantageous embodiment;

FIG. 7 is a diagram illustrating software components used to process yaw commands in accordance with an advantageous embodiment; and

FIG. 8 is a flowchart of a process for controlling an aircraft during flight in accordance with an advantageous embodiment.

### DETAILED DESCRIPTION

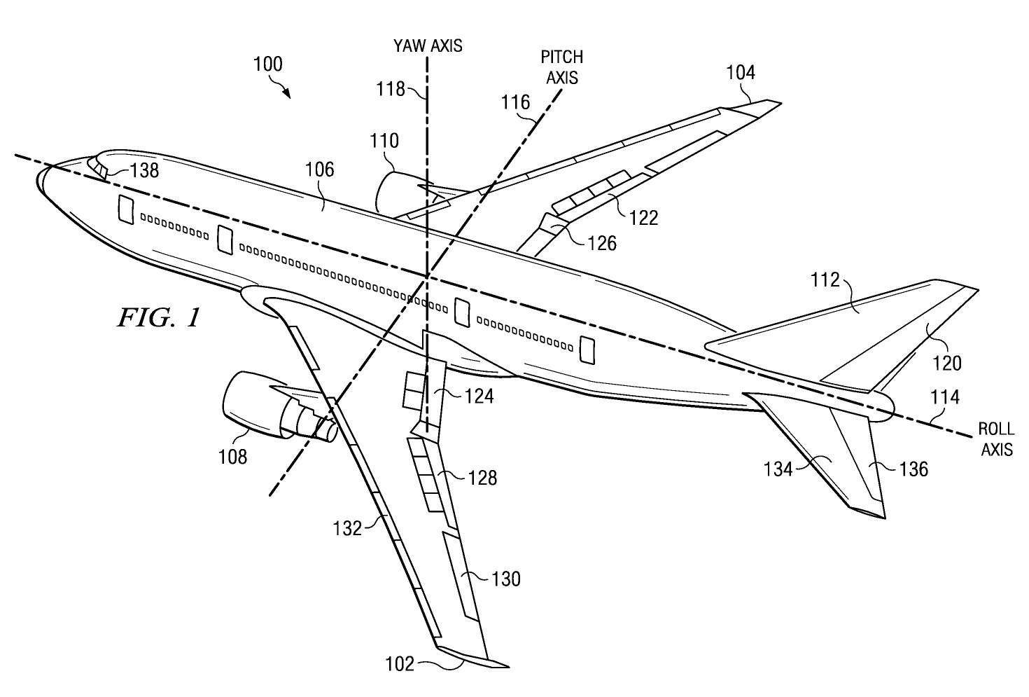

With reference now to the figures, and in particular with reference to FIG. 1, a diagram of an aircraft is depicted in which an advantageous embodiment may be implemented. Aircraft 100 is an example of an aircraft in which a method and apparatus for controlling aircraft 100 may be implemented. In this illustrative example, aircraft 100 has wings 102 and 104 attached to body 106. Aircraft 100 includes wing mounted engine 108, wing mounted engine 110, and vertical tail 112.

In these examples, aircraft 100 includes roll axis 114, pitch axis 116, and yaw axis 118. These axes are defined with respect to aircraft 100 in these examples. Aircraft 100 may bank or roll along roll axis 114. Aircraft 100 may change its pitch with respect to pitch axis 116. The yaw of aircraft 100 is centered around yaw axis 118. The position of aircraft 100 about these different axes defines the attitude of aircraft 100.

The position of aircraft 100 about these different axes may be controlled during flight through control effectors. A control effector is a device and/or component that may generate forces and moments to change the position of aircraft 100 during flight or on the ground. In these examples, in-flight control effectors may include control surfaces. Examples of control surfaces on aircraft 100 include, for example, without limitation, rudder 120, flap 122, flap 124, flaperon 126, spoiler 128, aileron 130, slat 132, stabilizer 134, and elevator 136. Other types of control effectors include devices and/or systems for controlling the differential thrust in wing mounted engines 108 and 110. When aircraft 100 is on the ground, examples of control effectors for on ground movement include a nose steering wheel and differential braking.

Currently, pitch and roll commands to control pitch and roll are input through a control stick in a cockpit of an aircraft. In contrast, yaw commands to control yaw are input through rudder pedals found in cockpit 138. With modern flight control applications, yaw control may be automatically coordinated and controlled through an electronic flight system. The use of direct yaw command input is becoming increasingly infrequent, especially for commercial transport aircraft, military cargo aircraft, tactical bombers, and strategic bombers. Further, the rudder pedals also may be used to control nose wheel steering while aircraft 100 is on the ground.

The different advantageous embodiments recognize that with the decreased use of direct yaw command inputs from operators, such as pilots, reductions in weight, cost, volume, and design complexity may be achieved by eliminating rudder pedal assemblies. With the elimination of a rudder pedal, controls for controlling the orientation or movement of aircraft 100 with respect to yaw are still needed. As a result, the different advantageous embodiments integrate yaw control with pitch and roll control with a single device or control system that may be located in cockpit 138.

In these examples, a yaw control may be implemented on the same control device or system as used for controlling pitch and roll. In these depicted embodiments, the device may take the form of an inceptor. An inceptor is a device that may be operated or manipulated by one or two hands of an operator, such as a pilot. An inceptor may be, for example, a control stick or yoke.

The different advantageous embodiments combine pitch control, roll control, and yaw control within a single device. In these examples, the yaw control may be implemented with a control stick having a twistable or rotatable grip to generate yaw input signals. In this manner, the need for rudder pedals in an aircraft, such as aircraft 100, may be eliminated.

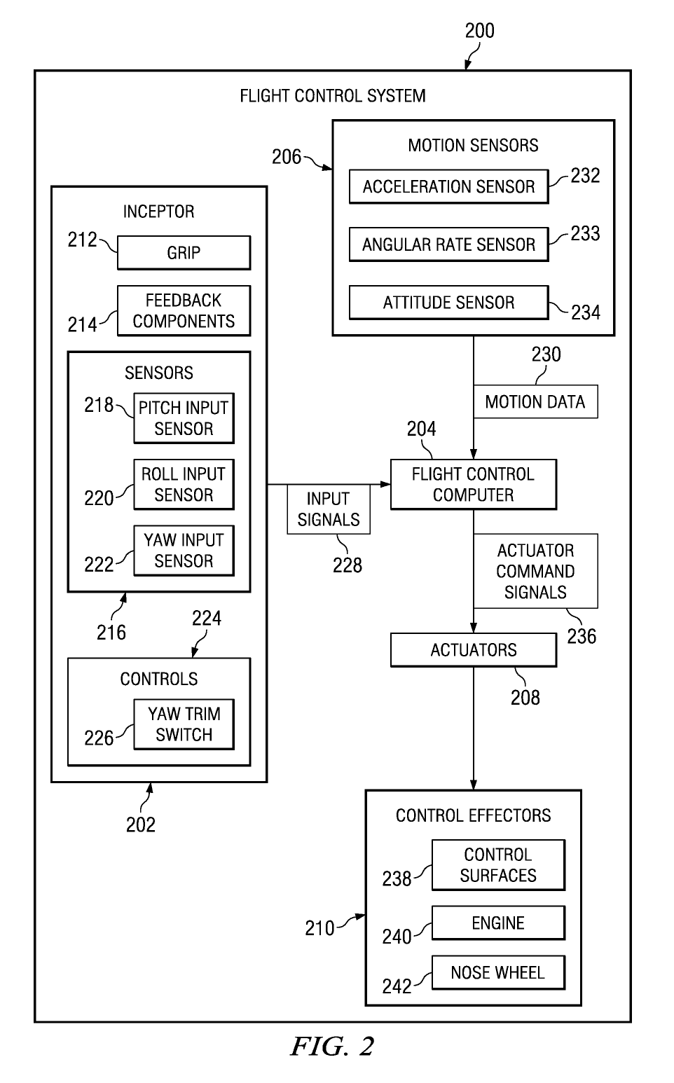

With reference next to FIG. 2, a block diagram illustrating components in a flight control system is depicted in accordance with an advantageous embodiment. In this example, flight control system 200 is an example of a flight control system that may be implemented in an aircraft, such as aircraft 100 in FIG. 1.

In this example, flight control system 200 includes inceptor 202, flight control computer 204, motion sensors 206, actuators 208, and control effectors 210. Inceptor 202 is used to control pitch, roll, and yaw. Inceptor 202 includes grip 212, feedback components 214, and sensors 216. Grip 212 is the physical structure of inceptor 202 on or in which feedback components 214 and sensors 216 may be integrated or placed.

Feedback components 214 provide feedback in response to manipulation of inceptor 202 by a human operator. Feedback components 214 may be a set of feedback components. A set used herein refers to one or more items. For example, a set of feedback components may be one or more feedback components. Feedback components 214 may be, for example, without limitation, a spring and/or a motor.

In these examples, if inceptor 202 is twisted about an axis, feedback components 214 may provide a force opposite to the twisting direction. Further, feedback components 214 also may include, for example, a detent, which represents a center point or default location for the position of grip 212. This detent may be indicated by a feedback, such as a click, when the detent is reached.

Feedback components 214 may provide more force as more input occurs. These components may provide an operator, such as a pilot, an indication of how close the pilot is to the end of the control capability. For example, with respect to twisting grip 212 around or about a yaw axis, the spring or motor may provide increasing amounts of resistance or force against the user twisting grip 212 as the limits of yaw control are approached in these examples.

Sensors 216, in these examples, include pitch input sensor 218, roll input sensor 220, and yaw input sensor 222. Pitch input sensor 218 detects movement of grip 212 to control aircraft 100 in FIG. 1 about an axis, such as pitch axis 116 in FIG. 1. Movement of grip 212 forward or backward is detected by pitch input sensor 218 to generate pitch input signals. Roll input sensor 220 may detect movement of grip 212 to control aircraft 100 in FIG. 1 about a roll axis, such as roll axis 114 in FIG. 1. Yaw input sensor 222 may detect movement of grip 212, such as a twisting movement to control aircraft 100 in FIG. 1 about a yaw axis, such as yaw axis 118 in FIG. 1.

In these depicted examples, inceptor 202 also includes controls 224. Controls 224 may be, for example, a set of switches. As illustrated, controls 224 comprises yaw trim switch 226. Yaw trim switch 226 is used to “set a trim” for the yaw input. In other words, if a pilot activates yaw trim switch 226 and then provides yaw input detected by yaw input sensor 222, the yaw input is maintained even though the operator may release inceptor 202. This activation of yaw trim switch 226 starts a yaw trim mode in which yaw input is maintained even after a user ceases twisting or manipulating grip 212 about the yaw axis.

This input may be canceled by deactivating yaw trim switch 226 or after some period of time depending on the particular implementation. Further, while yaw trim switch 226 is activated, additional input detected by yaw input sensor 222 may increase or decrease the yaw trim set for the aircraft. This additional input may take the form of a twisting motion with respect to grip 212 about a yaw axis.

This additional input also may be referred to as “bumping”, in which grip 212 is twisted towards a desired direction and released as the desired change in side slip or yaw is obtained. Bumping, in these examples, is a small momentary twist input to grip 212. The yaw trim mode may be canceled by selecting yaw trim switch 226 a second time.

The manipulation of inceptor 202 generates input signals 228, which are received by flight control computer 204 for processing. Input signals 228 include, for example, a pitch input signal, a roll input signal, a yaw input signal, and a yaw trim set switch input signal.

When yaw trim switch 226 is activated, inceptor 202 is in a trim mode. In this mode, yaw inputs are detected by yaw input sensor. Inceptor 202 may take various forms. For example, grip 212 may take the form of a stick, a yoke, or some other device manipulated by one or more hands of a pilot.

Flight control computer 204 also receives motion data 230 from motion sensors 206. These motion sensors may include, for example, acceleration sensor 232, angular rate sensor 233, and attitude sensor 234. Flight control computer 204 uses motion data 230 and input signals 228 to generate actuator command signals 236. These signals are sent to actuators 208 to manage control effectors 210.

Control effectors 210, in these examples, include control surfaces 238 and engine 240. Of course, these are only examples of some types of control effectors that may be present. Some control effectors may be used for controlling the movement of the aircraft in flight, while other control effectors are used for controlling the movement of the aircraft on the ground. An example of a ground control effector is a steerable nose wheel 242.

When the aircraft is on the ground, inceptor 202 may be used to control movement of the aircraft rather than using rudder pedals. For example, yaw input sensor 222 may be used to detect input to control the movement of the aircraft on the ground. As an example, yaw input sensor 222 may generate signals within input signals 228 to cause flight control computer 204 to activate actuators for nose wheel 242 to change direction of the aircraft.

As a further feature, flight control computer 204 may treat an input signal generated by yaw input sensor 222 with different amounts of gain depending on the mode of the aircraft. For example, a high gain mode may be present in which less force is required on grip 212 to generate the same steering control effort when aircraft 100 in FIG. 1 is slowly taxiing on the ground as compared to when aircraft 100 in FIG. 1 is moving at high speed on the ground.

High gain, low gain, and steering options may be implemented to provide for different levels of feedback through feedback components 214, depending on whether aircraft 100 in FIG. 1 is in the air or is moving slow or fast on the ground.

The different components shown in flight control system 200 are presented for purposes of illustrating one manner in which a flight control system may be implemented using an inceptor, such as inceptor 202. Of course, flight control system 200 may include other components in addition to or in place of the ones illustrated in this example. As can be seen in the different advantageous embodiments, yaw control is integrated as part of inceptor 202 along with the controls for pitch and roll. In this manner, weight and space associated with rudder pedals may be eliminated.

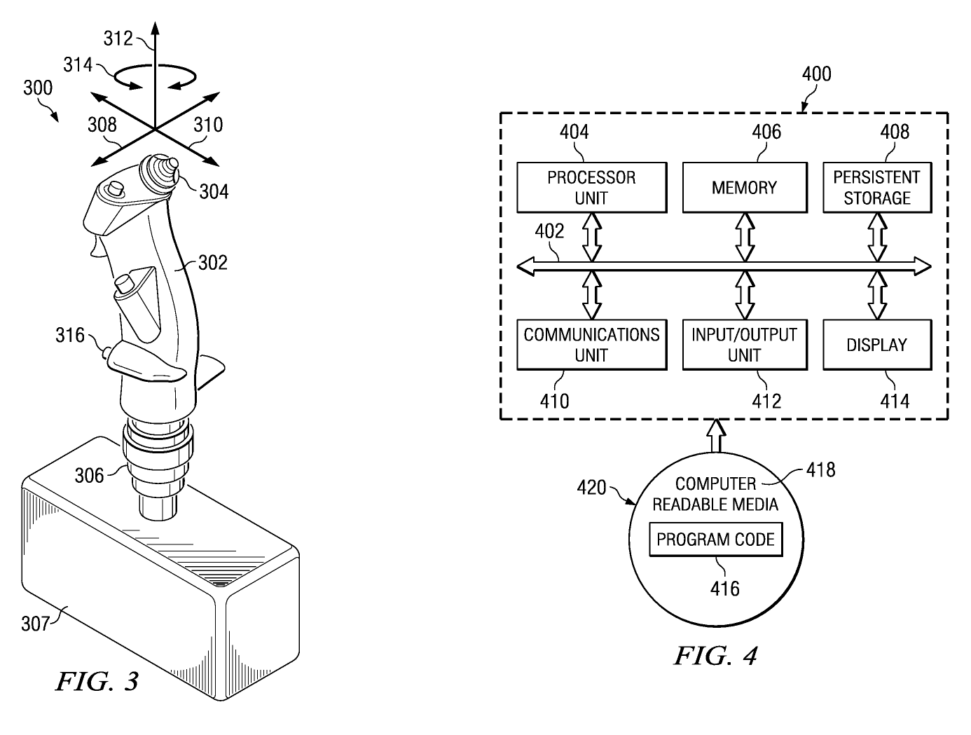

Turning now to FIG. 3, a diagram illustrating an inceptor is depicted in accordance with an advantageous embodiment. In this example, inceptor 300 is a pictorial example of one implementation of inceptor 202 in FIG. 2. As depicted, inceptor 300 includes grip 302. Grip 302 has free end 304 and fixed end 306 within housing 307. Inceptor 300 may be moved around fixed end 306 in a manner such that the different input sensors within housing 307 generate input signals for controlling movement of an aircraft.

For example, inceptor 300 may be moved laterally along the direction of arrow 308 to control the roll of an aircraft. Inceptor 300 may be moved longitudinally along the direction of arrows 310 to control the pitch of the aircraft. Further, inceptor 300 may be twisted around axis 312 in the direction of arrows 314 to control the yaw of the aircraft. Axis 312 is an axis similar to yaw axis 118 in FIG. 1.

Twisting of grip 302 about axis 312 along the direction of arrows 314 may require increasing exertion by a user as grip 302 is twisted farther about axis 312. This increased force needed by a user may be controlled through feedback components, such as feedback components 214 in FIG. 2. These components may be located in housing 307 along with a mechanism that may enable grip 302 to pivot. This increased force opposite to the twisting motion may increase proportionally with the desired yaw command input. When grip 302 is twisted in a counter-clockwise motion, a left yaw signal may be generated. A right yaw signal may be generated when grip 302 is twisted in a clockwise manner.

Also, inceptor 300 includes controls, such as yaw trim set switch 316. Activation of this switch may be used to detect yaw trim input in response to movement of inceptor 300 in the direction of arrows 314. Inceptor 300 may be used to control the yaw motion of an aircraft both in flight and on the ground. In flight, different control effectors may be changed in state to take into account forces, such as a cross wind.

On the ground, yaw control may be performed to change the direction of the aircraft as the aircraft moves on the ground. For example, when the aircraft moves from a runway to a taxiway, steering of the aircraft about a yaw axis may be controlled through inceptor 300. When on the ground, yaw trim set switch 316 may be used to change the gain for nose wheel steering.

Grip 302 also may have a detent position in which no yaw input is present. This position automatically occurs when the pilot relaxes the twist input on grip 302. This detent may be indicated by an audible indication, such as a click, when the grip returns to this position. The return of grip 302 to this position may be controlled with a feedback component, such as a spring or a motor.

As can be seen, the different advantageous embodiments integrate the control of the yaw axis with pitch and roll inputs in a control, such as inceptor 300. In this manner, there is no need for hand and foot coordination training as currently required with the use rudder pedals. Further, the use of inceptor 300 in the form a control stick as shown in FIG. 3 provides an intuitive nature to yaw command and control in the different advantageous embodiments. This type of control takes advantage of the fact that most yaw control is handled automatically by an electronic flight control system, such as flight control computer 204 in FIG. 2. The different advantageous embodiments may substantially reduce pilot workload.

The use of inceptor 300 is intuitive in nature in that sensors present within housing 307 and/or grip 302 and the hand motion required for different types of input are intuitive to the human operator when controlling movement of an aircraft. For example, yaw control is performed around an axis that is similar to the manner in which the operator manipulates grip 302. As a result, yaw steering in flight and on ground has an intuitive aspect with inceptor 300 based on the movements or manipulation of grip 302 required to control the yaw. For example, if the operator of inceptor 300 twists grip 302 in a clockwise motion, the yaw of the aircraft is controlled in the same clockwise motion with respect to the aircraft.

Turning now to FIG. 4, a diagram of a data processing system is depicted in accordance with an illustrative embodiment of the present invention. In this illustrative example, data processing system 400 may serve as a flight control computer 204 in FIG. 2. Data processing system 400 includes communications fabric 402, which provides communications between processor unit 404, memory 406, persistent storage 408, communications unit 410, input/output (I/O) unit 412, and display 414.

Processor unit 404 serves to execute instructions for software that may be loaded into memory 406. Processor unit 404 may be a set of one or more processors or may be a multi-processor core, depending on the particular implementation. Further, processor unit 404 may be implemented using one or more heterogeneous processor systems in which a main processor is present with secondary processors on a single chip. As another illustrative example, processor unit 404 may be a symmetric multi-processor system containing multiple processors of the same type.

Memory 406, in these examples, may be, for example, a random access memory or any other suitable volatile or non-volatile storage device. Persistent storage 408 may take various forms depending on the particular implementation. For example, persistent storage 408 may contain one or more components or devices. For example, persistent storage 408 may be a hard drive, a flash memory, a rewritable optical disk, a rewritable magnetic tape, or some combination of the above. The media used by persistent storage 408 also may be removable. For example, a removable hard drive may be used for persistent storage 408.

Communications unit 410, in these examples, provides for communications with other data processing systems or devices. In these examples, communications unit 410 is a network interface card. Communications unit 410 may provide communications through the use of either or both physical and wireless communications links.

Input/output unit 412 allows for input and output of data with other devices that may be connected to data processing system 400. For example, input/output unit 412 may provide a connection for user input through a keyboard and mouse. Further, input/output unit 412 may send output to a printer. Referring to FIG. 2 for this illustrative example, the input/output unit of the advantageous embodiment facilitates signal transfer from input signals 228 and motion data 230 into flight control computer 204 and from flight control computer 204 to actuator command signals 236. Now, referring back to FIG. 4, display 414 provides a mechanism to display information to a user. In this example, the display may be used to indicate left or right yaw control authority data.

Instructions for the operating system and applications or programs are located on persistent storage 408. These instructions may be loaded into memory 406 for execution by processor unit 404. The processes of the different embodiments may be performed by processor unit 404 using computer implemented instructions, which may be located in a memory, such as memory 406. These instructions are referred to as program code, computer usable program code, or computer readable program code that may be read and executed by a processor in processor unit 404. The program code in the different embodiments may be embodied on different physical or tangible computer readable media, such as memory 406 or persistent storage 408.

Program code 416 is located in a functional form on computer readable media 418 that is selectively removable and may be loaded onto or transferred to data processing system 400 for execution by processor unit 404. Program code 416 and computer readable media 418 form computer program product 420 in these examples. In one example, computer readable media 418 may be in a tangible form, such as, for example, an optical or magnetic disc that is inserted or placed into a drive or other device that is part of persistent storage 408 for transfer onto a storage device, such as a hard drive that is part of persistent storage 408.

In a tangible form, computer readable media 418 also may take the form of a persistent storage, such as a hard drive, a thumb drive, or a flash memory that is connected to data processing system 400. The tangible form of computer readable media 418 is also referred to as computer recordable storage media. In some instances, computer readable media 418 may not be removable.

Alternatively, program code 416 may be transferred to data processing system 400 from computer readable media 418 through a communications link to communications unit 410 and/or through a connection to input/output unit 412. The communications link and/or the connection may be physical or wireless in the illustrative examples. The computer readable media also may take the form of non-tangible media, such as communications links or wireless transmissions containing the program code.

The different components illustrated for data processing system 400 are not meant to provide architectural limitations to the manner in which different embodiments may be implemented. The different illustrative embodiments may be implemented in a data processing system including components in addition to or in place of those illustrated for data processing system 400. Other components shown in FIG. 4 can be varied from the illustrative examples shown.

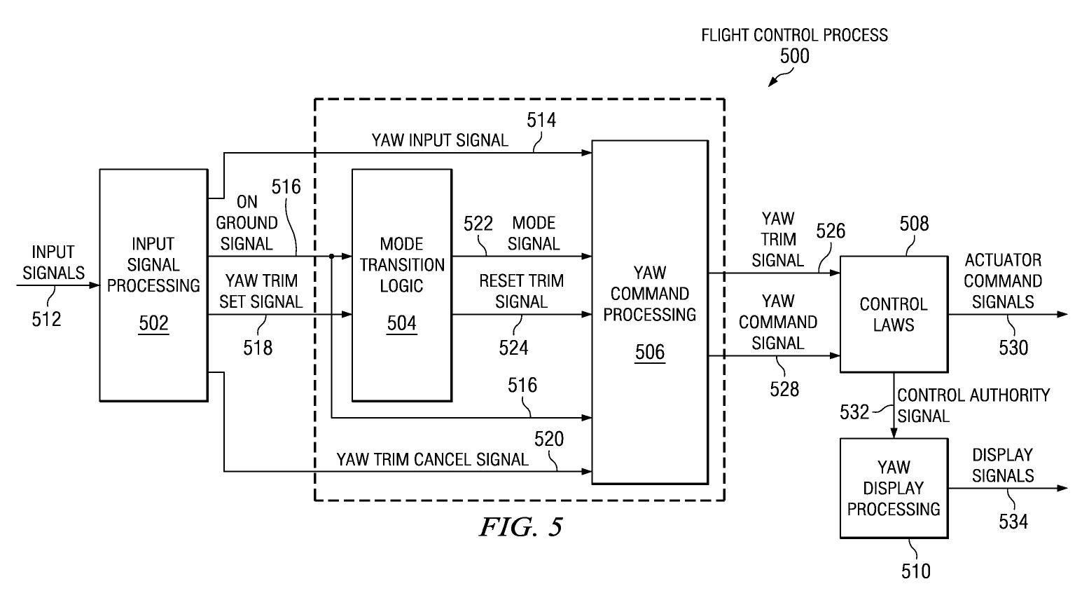

With reference next to FIG. 5, a diagram illustrating software components that may be used in a flight control computer is depicted in accordance with an advantageous embodiment. In this example, flight control process 500 is an example a software process that may execute on a data processing system, such as data processing system 400 in FIG. 4, when implemented as a flight control computer, such as flight control computer 204 in FIG. 2.

Flight control process 500 includes various components, such as, for example, input signal processing 502, mode transition logic 504, yaw command processing 506, control laws 508, and yaw display processing 510. Input signal processing 502 receives input signals 512. These input signals are similar to input signals 228 and motion data 230 in FIG. 2.

Input signal processing 502 outputs yaw input signal 514, on ground signal 516, yaw trim set signal 518, and yaw trim cancel signal 520. Yaw input signal 514 is generated in response to sensors detecting movement of an inceptor about a yaw axis. Yaw trim set signal 518 may be generated when a control is activated to set the yaw trim. Yaw trim cancel signal 520 may be generated when the same control is deactivated.

On ground signal 516 may be detected based on information, such as the weight of the aircraft on the nose wheel, the speed of the aircraft, or the movement of the nose wheel. This type of information may be gathered from sensors, such as motion sensors 206 in FIG. 2.

These different signals are used by mode transition logic 504 and yaw command processing 506 to process input from a pilot with respect to yaw input commands applied to an inceptor, such as inceptor 202 in FIG. 2.

Mode transition logic 504 may output mode signal 522. Mode signal 522 may indicate, for example, that yaw input signal 514 is to be used to control nose wheel steering when the aircraft is on the ground or yaw attitude when the aircraft is in flight. Mode signal 522 may also indicate that yaw input signal 514 is to be used to control yaw trim when the aircraft is in flight. Yaw input signal 514 is treated differently when the aircraft is in control mode as opposed to when the aircraft is in trim mode. Additionally, mode transition logic 504 may generate reset trim signal 524.

These signals, as well as other signals generated by input signal processing 502, are used by yaw command processing 506 to generate yaw trim signal 526 and yaw command signal 528. Yaw trim signal 526 may be used to set the yaw trim, effectively holding a yaw bias, while yaw command signal 528 is used to apply additional yaw movement relative to the held yaw bias.

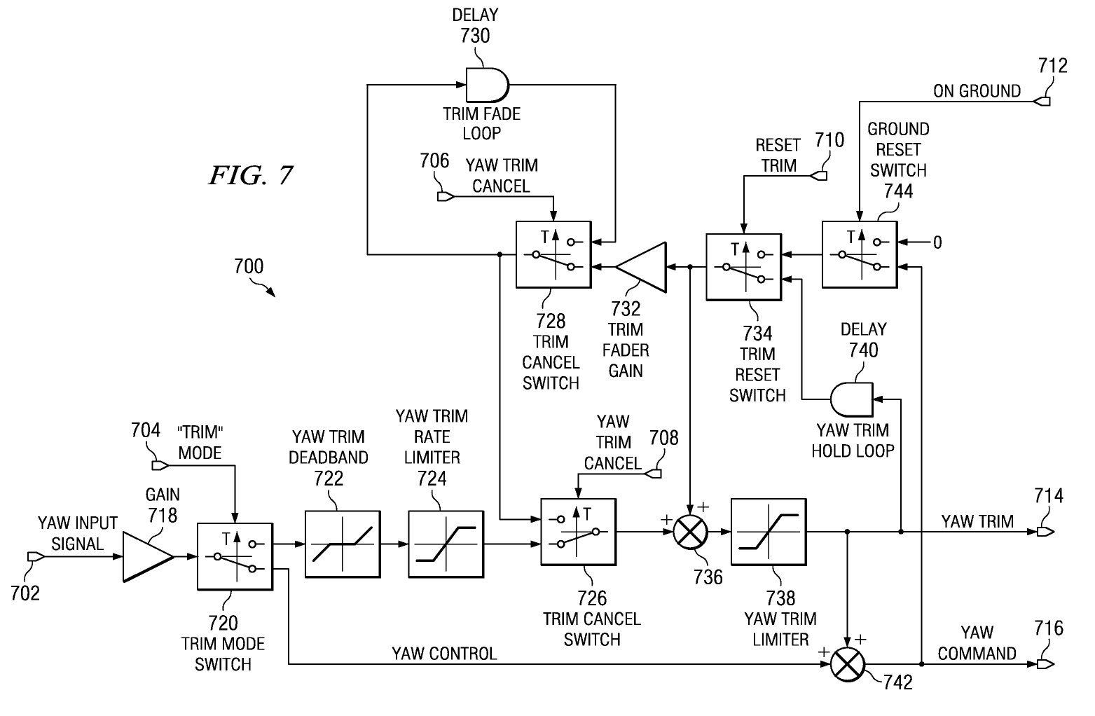

These signals are sent to control laws 508. Control laws 508 process yaw trim signal 526 and yaw command signal 528 through a sequence of computer instructions to form actuator command signals 530. The computer instructions may include yaw command processing components as in FIG. 7, control law feedback architectures of various configurations, control authority distribution algorithms, and other aircraft specific control law components. Control laws 508 output a set of signals that may be used to actuate or make changes to the state of various control effectors.

The state of a control effector imparts forces and moments to change the movement or orientation of an aircraft. For example, a state may be a particular direction in which thrust vectoring may act. Another state may be, for example, the angle at which a nose wheel is turned. Yet another state may include, for example, the position of a rudder, flap, or an aileron.

In these examples, actuator command signals 530 are used to control or manage control effectors to change the yaw of the aircraft. The flow in processing of other input signals used to control pitch and roll are not illustrated in these examples.

Additionally, control laws 508 also generate control authority signal 532. This signal is sent to yaw display processing 510, which in turn generates display signals 534 of the change based on the operator input from the set trim bias for display on a display device, such as one attached to data processing system 400 in FIG. 4 or otherwise in communication with a flight control computer.

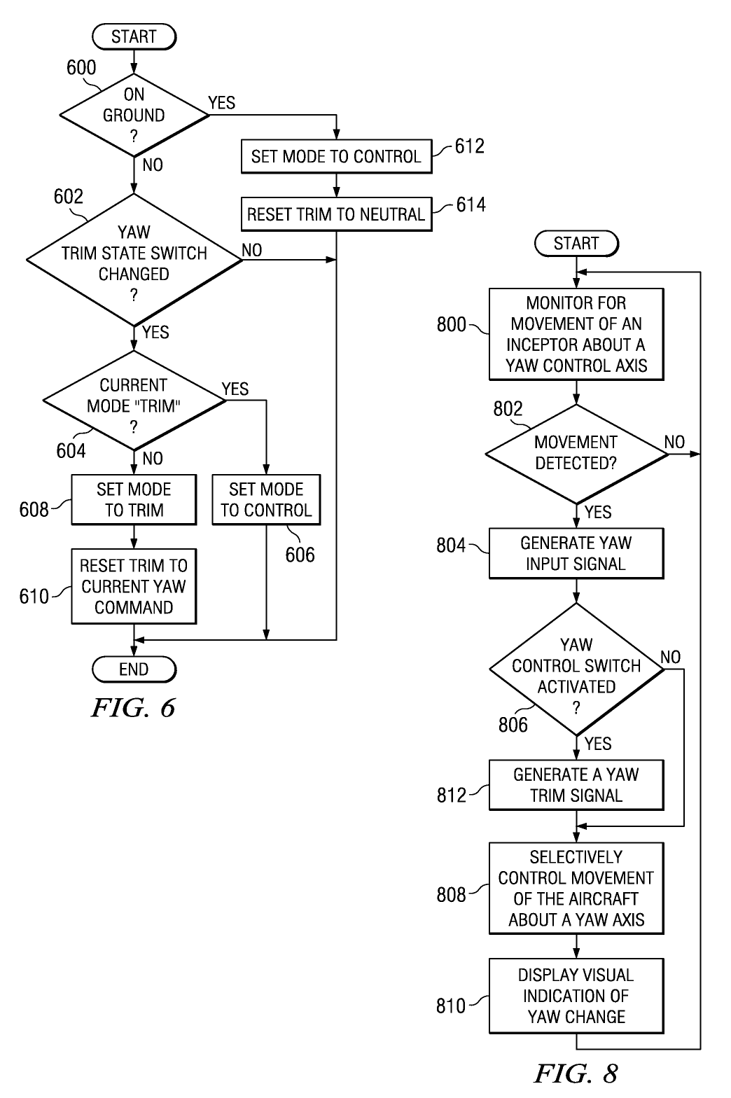

Turning now to FIG. 6, a flowchart of a process for handling mode transitions is depicted in accordance with an advantageous embodiment. The process illustrated in FIG. 6 may be implemented in mode transition logic 504 in FIG. 5. In particular, the process illustrated in FIG. 6 is used to indicate whether a control mode or a trim mode is present. A control mode is present when the aircraft is on the ground or in flight while a trim mode may be present when the aircraft is in the air.

The process begins by determining whether the aircraft is on the ground (operation 600). This determination may be made through various mechanisms or systems. For example, the aircraft may be identified as being on the ground through identifying the weight on the wheel, wheel speed, or ground speed as identified by ground speed sensors. These may be used individually or in combination with other systems to determine whether the aircraft is on the ground.

If the aircraft is not on the ground, a determination is made as to whether the yaw trim has been set (operation 602). In these examples, whether the yaw trim has been set may be identified by detecting the change in state of a switch, such as switch 316 in FIG. 3. Of course, the switch may be integrated as part of inceptor 300 in FIG. 3 or may be a separate switch in another location.

If the switch state has changed, a determination is made as to whether the current mode is “trim”. If the current mode is a trim mode, the mode is set to a control mode (operation 606). The process then terminates.

With reference again to operation 604, if the current mode is not trim, the mode is set to trim (operation 608). In operation 610, the amount of yaw trim is reset to the particular trim command that has been detected by sensors at the inceptor. The process then terminates.

For example, if manipulation of the inceptor causes a particular change in yaw by changing the position of the flaps, this flap position may be maintained as long as the trim mode is set without requiring the user to continually apply force or manipulate the inceptor. In other words, the pilot may release or cease twisting the inceptor and maintain the same flap position.

With reference again to operation 602, if the switch state has not changed, the process terminates without any further actions being taken. With reference again to operation 600, if the aircraft is on the ground, the process sets the mode to control (operation 612). In operation 612, the control mode asserted on the ground is the same control mode as asserted in flight. The difference in these examples between flight and ground is that on the ground, control commands are routed to the nose wheel for steering.

In operation 612, yaw input signals detected at the inceptor may be used to change the direction of the aircraft by control effectors designed for ground movement. These control effectors may be, for example, the nose wheel and wheel brakes.

Further, the change in mode also may change the gain or amount of force needed on an inceptor to cause a change in yaw. For example, the force needed to twist an inceptor may be greater when a control mode is present on the ground as opposed to a trim mode in the air. The process then resets the trim to neutral (operation 614), with the process terminating thereafter. Resetting the trim to neutral, in these examples, causes control effectors to reset to a desired or pre-selected configuration to allow the aircraft to experience a smooth takeoff.

Thus, the process illustrated in FIG. 6 allows for a transition between different modes for handling yaw input. Further, this process also allows a reset of the yaw input to a neutral input, such as a zero value for a side slip for in air operations.

As a result, the reset of the yaw input as well as the different gain levels that are present for different types of situations also add to the intuitive nature of the control provided by the inceptor illustrated in the different advantageous embodiments. For example, if the gain is decreased as the speed increases such that it takes more force to twist or bump the inceptor, this provides an additional intuitive feature in the feedback given to the operator with different speeds of wheels on the runway or taxi, as well as different speeds in flight.

Turning now to FIG. 7, a diagram illustrating software components used to process yaw commands is depicted in accordance with an advantageous embodiment. The components illustrated in FIG. 7 are examples of software components that may be used to implement yaw command processing 506 in FIG. 5.

In these examples, input 702 receives a signal, such as yaw input signal 514 in FIG. 5. Input 704 receives an input signal, such as mode signal 522 in FIG. 5. Input 706 and input 708 may receive an input signal, such as yaw trim cancel signal 520 in FIG. 5. Input 710 may receive a signal, such as reset trim signal 524 in FIG. 5. Input 712 may receive a signal, such as on ground signal 516 in FIG. 5.

In response to receiving these inputs, yaw command processing 700 may generate output signals at outputs 714 and 716. Output 714 may output a signal, such as yaw trim signal 526 in FIG. 5, while output 716 may output a signal, such as yaw command signal 528 in FIG. 5.

Yaw command processing 700 includes components, such as gain 718, trim mode switch 720, yaw trim deadband 722, yaw trim rate limiter 724, trim cancel switch 726, trim cancel switch 728, delay 730, trim fader gain 732, trim reset switch 734, sum junction 736, yaw trim limiter 738, delay 740, sum junction 742, and ground reset switch 744.

In these examples, gain 718 may increase or decrease the strength of the yaw input signal applied to input 702. Trim mode switch 720 may be used to route the yaw input signal along the appropriate trim mode signal path or control mode signal path depending upon the trim mode or control mode setting from the mode transition logic 504 in FIG. 5. If a trim mode signal is present at input 704, the output of gain block 718 flows along the yaw trim path into the yaw trim dead band 722 and rate limiter 724. Otherwise, it flows along the control mode signal path to the summing junction 742.

Yaw trim deadband 722 and yaw trim rate limiter 724 serve to desensitize the yaw input signal to the operator's “bumping” motion. The yaw trim deadband 722 ensures that a minimum amount of inceptor rotation in either direction is required to affect a trim change. Similarly, the yaw trim rate limiter 724 imposes an upper limit on the speed at which trim change can be affected. In other words, these two functions work together such that the yaw inceptor does not feel overly sensitive at any position within its rotation range to the operator.

Trim cancel switches 726 and 728, along with delay 730 and trim fader gain 732 serve to close the trim fade loop, which allows the operator to smoothly fade the yaw trim setting to neutral when such trim setting is no longer required or desired. The trim fade loop is activated when yaw trim cancel signals 706 and 708 are set.

Normally, trim cancel switch 728 is configured to select the output of trim fader gain 732. Likewise, trim cancel switch 726 is normally configured to select the output from yaw trim rate limiter 724. When yaw trim cancel signals 706 and 708 are set, trim cancel switch 726 begins selecting the output of trim cancel switch 728, which in turn begins selecting the output of delay 730. Delay 730 stores the last pass output of trim cancel switch 728.

Summing junction 736, yaw trim limiter 738, delay 740, and trim reset switch 734 form the yaw trim hold loop. The yaw trim hold loop serves to select and hold the last trim input from the operator, allowing the operator to release the yaw inceptor to neutral without affecting a change in yaw trim. Summing junction 736 adds the output of trim cancel switch 726 with the output of trim reset switch 734, allowing the operator to increment or decrement the yaw trim by bumping the yaw inceptor in the desired direction.

Yaw trim limiter 738 imposes limits on the output from summing junction 736, thus restricting the amount of yaw trim that can be held by the Yaw Trim Hold loop. Delay 740 stores the last pass output of yaw trim limiter 738. Trim reset switch 734 is normally configured to select the output from delay 740. However, when reset trim signal 710 is asserted, trim reset switch 734 selects the output of the ground reset switch 744, allowing the trim hold loop to capture and hold a new trim setting.

Ground reset switch 744 is normally configured to select the output of summing junction 742 which is yaw command output signal 716. When on ground signal 712 is asserted, ground reset switch 744 begins selecting zero (neutral) yaw trim. This function allows the yaw trim to neutralize when the aircraft is on the ground and reset trim signal 710 is asserted.

Summing junction 742 adds the yaw control input to the captured and held yaw trim output signal 714, allowing the user to command yaw relative to the held yaw trim bias.

The different components illustrated in FIG. 7 are examples of software components that may be used to implement yaw command processing 506 within flight control process 500 in FIG. 5. These different blocks are provided to illustrate functions and processes used to process inputs to generate output signals to change the state of control effectors. As mentioned above, the change in state may be to change the position of a control surface, change the vectoring of an engine, change the amount of thrust of an engine, or some other suitable change in state in a control effector.

Turning now to FIG. 8, a flowchart of a process for controlling an aircraft during flight is depicted in accordance with an advantageous embodiment. The process illustrated in FIG. 8 may be implemented in a flight control system, such as flight control system 200 in FIG. 2. In particular, the different operations illustrated in FIG. 8 may be implemented in flight control process 500 in FIG. 5.

The process begins by monitoring for movement of an inceptor about a yaw control axis (operation 800). This monitoring may be made using a set of sensors that detect movement of the inceptor around a yaw control axis. A determination is made as to whether movement has been detected (operation 802). If movement has not been detected, the process returns to operation 800).

If movement has been detected, a yaw input signal is generated (operation 804). Further, a determination is made as to whether a yaw control switch has been activated (operation 806). If a yaw control switch has not been activated, then movement of the aircraft is selectively controlled about a yaw axis based on the input signal (operation 808).

The process then displays a visual indication of the yaw change (operation 810). In operation 810, the visual indication may be, for example, an indication of the trimmed and/or commanded sideslip amount that is present in response to the user input. With this indication, the user may desire to increase or decrease the amount by “bumping” the inceptor, as described above, when the inceptor is in a trim mode. The process then returns to operation 800.

With reference again to operation 806, if a yaw control switch has been activated, a yaw trim signal is generated (operation 812). The process then returns to operation 808 to selectively control the movement of the aircraft about a yaw axis based on both the yaw input signal and the yaw trim signal.

Thus, the different advantageous embodiments provide a method and apparatus for controlling movement of an aircraft about a yaw axis with a control apparatus that also may be used to control the pitch and roll of the aircraft. The different advantageous embodiments eliminate a need for rudder pedals to control yaw in an aircraft. The depicted embodiments include an inceptor that allows for detecting pitch, roll, and yaw input in a single device. In the illustrative examples, the inceptor takes the form of a control stick that may be twisted about a yaw axis or other axis to control aircraft yaw.

In the different embodiments, a control or switch may be used to set and reset yaw trim modes. Also, a flight control system and a set of feedback components may be present. The set of feedback components may provide a restoring force in the opposite direction that a user twists the grip to change the amount of force needed to twist the grip in generating yaw input.

Without needing rudder pedals, weight and space is freed up in the cockpit of an aircraft. Further, a three-axis control input from a single device is provided in a manner to reduce pilot workload. Further, generating yaw input along with a yaw trim switch also may relieve pilot exertion during prolonged yaw command situations. Further, the use of the yaw control also may be implemented during ground operations to eliminate redundant pedal and tiller systems currently used to steer the aircraft.

Additionally, training and dexterity needed for hand and foot coordination are not needed with the different advantageous embodiments. Further, a potential for rudder pedal jamming, breakage, and/or failure caused by loose or dropped objects in the cockpit may be eliminated.

Although the different advantageous embodiments have been described with respect to a control system for an aircraft, the different advantageous embodiments also may be implemented for use in other vehicles. For example, these control systems illustrated in the different examples may be implemented in a space craft, a submarine, or other suitable vehicles in which yaw control may be desired.

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of computer usable or readable program code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

The description of the different advantageous embodiments have been presented for purposes of illustration and description, and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A control system for an aircraft, the control system comprising:
a grip;
a set of feedback components connected to the grip, wherein the set of feedback components transmit a restoring force opposite to a movement of the grip; and
a set of sensors capable of detecting pitch input, roll input, and yaw input in response to the movement of the grip.

2. The control system of claim 1, wherein the grip has a fixed end and pivots about the fixed end.

3. The control system of claim 2, wherein the set of sensors detect the pitch input, the roll input, and the yaw input in response to the movement of the grip about the fixed end.

4. The control system of claim 1, wherein the set of sensors detect the yaw input from the movement in a form of a twisting motion of the grip around an axis through the grip.

5. The control system of claim 1, wherein the set of feedback components comprises at least one of a spring, a motor, and an actuator.

6. The control system of claim 1 further comprising:
a set of control switches connected to the grip.

7. The control system of claim 1, wherein the set of control switches comprises a yaw trim control switch, wherein activation of the yaw control switch sets a yaw trim in the yaw input detected by the set of sensors.

8. The control system of claim 1, wherein the grip has a detent.

9. The control system of claim 1 further comprising:
a plurality of flight effectors capable of being moved to alter a flight of the aircraft;
a plurality of flight control actuators connected to the plurality of flight effectors; and
a flight control computer connected to the plurality of flight control actuators and to a plurality of sensors, wherein the flight control computer is capable of selectively activating the plurality of flight control actuators in response to receiving an input signal from the plurality of sensors.

10. The control system of claim 1, wherein a sensor within the set of sensors detects movement of the grip around the axis to detect the yaw input.

11. The control system of claim 1, wherein the grip, the set of feedback components, and the set of sensors provide an intuitive operation in the manipulation of the grip by a human operator with respect to controlling the direction of the aircraft.

12. The control system of claim 11, wherein the set of feedback components provide the restoring force opposite to the movement of the grip with respect to the yaw input that changes with respect to different speeds of the aircraft on the ground or in flight.

13. An apparatus comprising:
a flight control computer;
an inceptor connected to the flight control computer, wherein the inceptor is capable of detecting pitch input, roll input, and yaw input generated by an operator manipulating a hand controller; and
a plurality of flight control actuators in communication with the flight control computer and connected to a plurality of control effectors, wherein an input detected by the inceptor is translated into a signal by the flight control computer to selectively activate a set of flight control actuators in the plurality of flight control actuators.

14. The apparatus of claim 13 further comprising:
the plurality of control effectors capable of changing state in response to activation of the plurality of flight control actuators.

15. The apparatus of claim 14, wherein the plurality of flight control effectors comprises a plurality of control surfaces.

16. The apparatus of claim 13, wherein the inceptor comprises:
a grip;
a set of feedback components connected to the grip, wherein the set of feedback components transmit a restoring force opposite to a movement of the grip; and
a set of sensors capable of detecting the pitch input, the roll input, and the yaw input in response to the movement of the grip.

17. The apparatus of claim 16, wherein a sensor within the set of sensors detects the movement of the grip around an axis to detect the yaw input.

18. The apparatus of claim 13, further comprising:
an aircraft, wherein the flight control computer, the inceptor, and the plurality of flight control actuators are located in the aircraft.

19. A method for controlling an aircraft during flight, the method comprising:
detecting movement of an inceptor about a yaw control axis, wherein the inceptor is capable of movement to generate input for pitch, roll, and yaw of the aircraft;
generating a yaw input signal in response to detecting the movement of the inceptor about the yaw control axis; and
selectively changing a state of a set of control effectors capable of controlling movement of the aircraft about a yaw axis for the aircraft in response to the yaw input signal.

20. The method of claim 19 further comprising:
generating a yaw trim set signal if a yaw trim control switch is activated; and wherein the selectively controlling step further comprises:
selectively changing the state of the set of control effectors capable of controlling the movement of the aircraft about the yaw axis in response to the yaw input signal and the yaw trim set signal.
